(19) United States
(12) Patent Application Publication
(10) Pub. No.: US 2009/0246732 A1
(43) Pub. Date: Oct. 1, 2009

(54) Dental tool

(76) Inventors: Susan M. Creasman, Andrews, NC (US); Deborah E. Creasman, Delray Beach, FL (US)

Correspondence Address: MALLOY & MALLOY, 2800 S.W. THIRD AVENUE, HISTORIC CORAL WAY, MIAMI, FL, 33129, US

(21) Appl. No.: 11/713,259

(22) Filed: Mar. 2, 2007

Related U.S. Application Data
(60) Provisional application No. 60/875,904, filed on Dec. 20, 2006.

(51) Int. Cl. A61C 3/00

(52) U.S. Cl. 433/141

(57) ABSTRACT

A hand held dental tool for removing dental prostheses and dental appliances from a user's mouth comprises a handle that facilitates a sturdy grip and an engagement head affixed an end of the handle for engaging the prosthesis of appliance. The engagement head has dual fingers extending oppositely away from the head wherein a first finger extends upwardly from the head and a second finger extends downwardly from the head for engaging lower and upper prostheses respectively.

### CROSS-REFERENCE TO RELATED APPLICATION

This application claims the benefit of co-pending U.S. Provisional Patent Application Ser. No. 60/875,904, filed on Dec. 20, 2006, which is incorporated herein in its entirety.

### BACKGROUND OF THE INVENTION

1. Field of the Invention

The present invention relates to dental instruments in general and more particularly to dental instruments to aid in the removal of dental appliances.

2. Discussion of the Related Art

Dental hygiene and tooth maintenance is a very important part of everyday life. Healthy teeth are not only aesthetically pleasing, but are also a necessary and vital part of our daily routine of food consumption. A full set of teeth allow us to chew our food to aid in the digestive process, thus we place a high emphasis dental care to retain as many of our natural teeth as possible. However, over the centuries, humans have been contending with the loss of some or all of their teeth as a result of accidents, injuries, or oral disease, and the loss of teeth remains a problem to this day in spite of the advances of modern dental medicine. Since the human body does not naturally replace missing teeth, dental prosthetics have been developed to provide artificial teeth.

Dental prosthetics, also known as dental appliances, have been utilized for centuries, starting with crude ill fitting dentures made of wood or bone. These initial attempts at dental prosthetics, while an improvement over having no teeth, suffered from the problem of retention, or more specifically, how well the denture is prevented from moving in the vertical plane in the opposite direction of insertion. Initially, retention of mandibular (lower) dentures and more particularly maxillary (upper) dentures relied on conforming the interior surface of the denture to closely mimic the topographical contours of the portion of the mouth in which the dentures were to be retained. For the dentures that relied solely on matching the contour of the mouth and more specifically the mucosa that underlies the dentures, retention relied on the forces of surface tension, suction, plain old friction, and even adhesives to keep the dentures from becoming dislodged. Dentures that relied solely on these forces, while greatly restoring aesthetics, restored only a small portion of the person's original tooth function for biting and chewing. Further, after a person has used dentures for a time period, the underlying bone in the person's jaw, and more specifically the alveolar bone in which the teeth normally reside, has tended to shrink and atrophy thereby causing well fitting dentures to now become ill fitting dentures with an undesirable decrease in retention.

Full dentures are only a part of the dental prosthetic universe. Other forms of dental prosthetics include partial dentures and fixed and removable bridges. Fixed bridges are permanently affixed to neighboring teeth and do not need to be removed on a regular basis. However, full dentures, partial dentures, and removable bridges do need to be removed on a regular basis for cleaning and for personal hygienic reasons. Food particles can become lodged in the areas between a person's natural teeth and the prosthetic or even between the mucosa and the prosthetic. Some partials and removable bridges can held in place with stainless steel wires that are closely formed to the interior surfaces of adjoining teeth and are then anchored to the teeth utilizing a clasp formed with the wire such as a ball clasp which engages an undercut formed by two adjacent teeth.

As the practice of dental prosthetics has progressed over the years through scientific discovery, experimentation and innovation, researchers have made some important discoveries. One of the discoveries is that the forces of biting and chewing which are normally transferred by the teeth to the alveolar bone is the mechanism by which the alveolar bone is maintained in good health, and that the absence of those directly transferred forces is what causes the atrophying of the bone. Thus, implants have now become an accepted practice for introducing dental prosthetics to replace missing teeth. An implant is usually a post that is embedded in the alveolar bone, and after a healing period the dental prosthetic is attached to it. A single implant can be utilized to support one missing tooth, or two or more implants can support a partial denture, removable bridge, or even a full denture. The implants greatly improve the retention factor by the inclusion of a clasping mechanism between the post/implant and the prosthetic device.

Concurrent with these advances in dental prosthetic retention are the problems of prosthetic removal for those devices that are meant to be removed on a regular basis for cleaning and oral hygiene. Whether the retention is that of suction, surface tension and adhesive forces on an upper maxillary denture or the forces required to overcome the mechanical clasping of a partial denture on implants, the increased retention forces of today's prosthetics also increases the removal forces required to dislodge the removable prosthetic. Often the prosthetic wearer's options for removal of the device are grasping the device and pulling, or alternatively, attempting to hook a fingernail on an edge of the device and applying force to dislodge the device. Neither of these methods is desirable, since grasping forces on the device are often countered by the presence of saliva or other viscous compounds on the device. Likewise, attempting to hook a fingernail behind a feature of the device can cause injury to the underlying mucosa with the risk of infection and prolonged discomfort until the injured tissue heals. This problem is particularly acute among the elderly, frail and disabled who are also the ones most likely to use dental prosthetics and appliances. The difficulty of removal often results in these users leaving the appliances in and thus forgoing the cleaning and oral hygiene required for good dental health.

Thus what is desired is a dental instrument to aid in the removal of dental prosthetics and appliances to overcome the retention forces of the dental device whether by suction, implants, or wire clasps.

### SUMMARY OF THE INVENTION

The present invention is directed to a hand held dental tool that satisfies the need to overcome dental prosthetic and appliance retention forces to easily and safely remove the prosthetic or appliance. The hand held dental tool comprises a handle that facilitates a sturdy grip and an engagement head affixed an end of the handle for engaging the prosthesis or appliance. The engagement head has dual fingers extending oppositely away from the head wherein a first finger extends upwardly from the head and a second finger extends downwardly from the head for engaging lower and upper prostheses respectively.

Another aspect of the present invention is a hand held dental tool for removing dental prostheses and dental appliances from a user's mouth wherein the dental tool has a shaft like handle having first and second ends with a neck extending from the first end. A first dual fingered head is formed at an end of the neck opposite from the handle with a first finger extending downwardly from the head and an opposing second finger extending upwardly from the head. The fingers can employ different shapes to facilitate dislodging of the prosthesis from the user's mouth.

Yet another aspect of the present invention is a hand held dental tool for removing dental prostheses and dental appliances from a user's mouth that includes a handle and a head for engaging a dental appliance to be removed. The head further has a first arm and second arm wherein each arm extends away from the handle and each said arm has a suction cup affixed to a free end thereof. The suction cups are laterally separated one from the other and are substantially coplanar.

These and other features, aspects, and advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is an elevation view of a dental tool embodying the present invention including an upwardly extending finger and a downwardly extending finger;

FIG. 2 is an elevation view of a dental tool embodying the present invention wherein an alternate engagement head embodiment is affixed to both ends of a handle;

FIG. 3 is an elevation view of a dental tool embodying the present invention including an alternate embodiment of an engagement head;

FIG. 4 is an elevation view of a dental tool embodying the present invention and having an alternate embodiment engagement head with an angled neck;

FIG. 5 is an elevation view of a dental tool embodying the present invention and having an alternate embodiment engagement head with a bifurcated neck and one finger at the end of each arm of the neck;

FIG. 6 is an elevation view of an alternate embodiment of the dental tool wherein the head includes a bifurcated neck with a suction cup affixed to the ends of each arm of the bifurcated neck;

FIG. 7 is an elevation view of a dental tool embodying the present invention wherein the engagement head is removable from a handle having a hollow interior and the handle includes a removable panel for access to the interior;

FIG. 8 is a reverse elevation view of a dental tool embodying the present invention and similar to the tool of FIG. 7 wherein access to the handle interior is obtained through a removable cap at the end of the handle;

FIG. 9 is a perspective view of a dental tool as embodied by FIG. 7 wherein one of the fingers is dislodging a ball clasp of a dental appliance;

FIG. 10 is a perspective view of the dental tool as embodied by FIG. 3 dislodging a full maxillary denture from a user's mouth;

FIG. 11 is a perspective view of the dental tool as embodied by FIG. 3 dislodging a full mandibular denture from a user's mouth;

FIG. 12 is a perspective view of the dental tool as embodied by FIG. 3 dislodging a partial mandibular denture from a user's mouth;

FIG. 13 is a perspective view of the dental tool as embodied by FIG. 7 dislodging a partial maxillary denture from a user's mouth.

Like reference numerals refer to like parts throughout the several views of the drawings.

### DETAILED DESCRIPTION OF THE PREFERRED EMBODIMENT

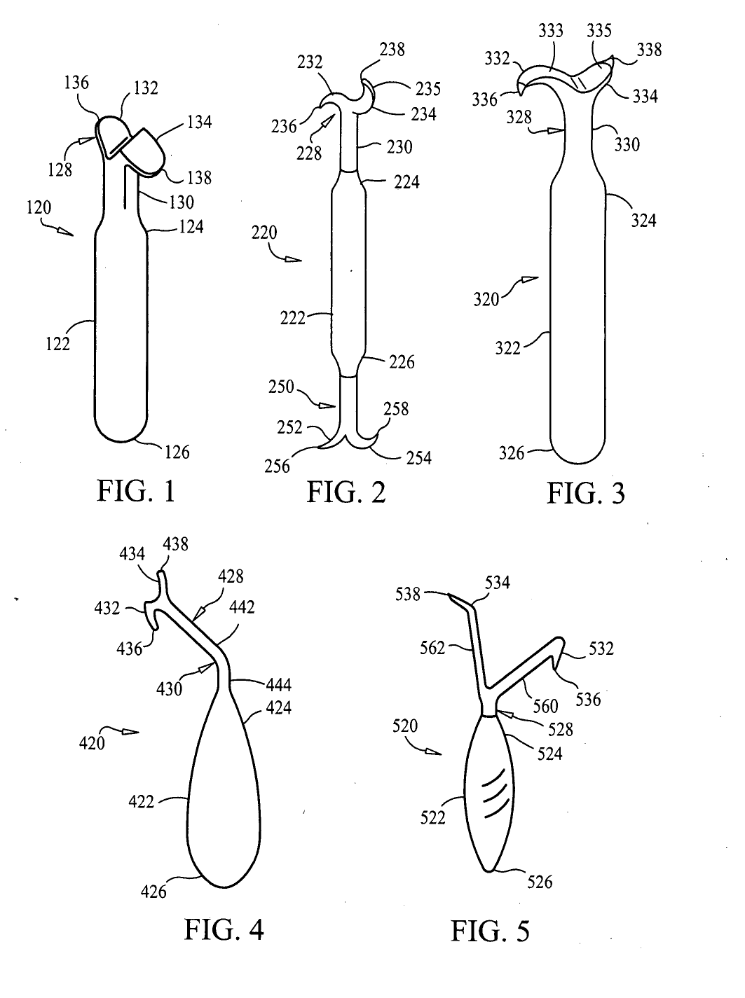

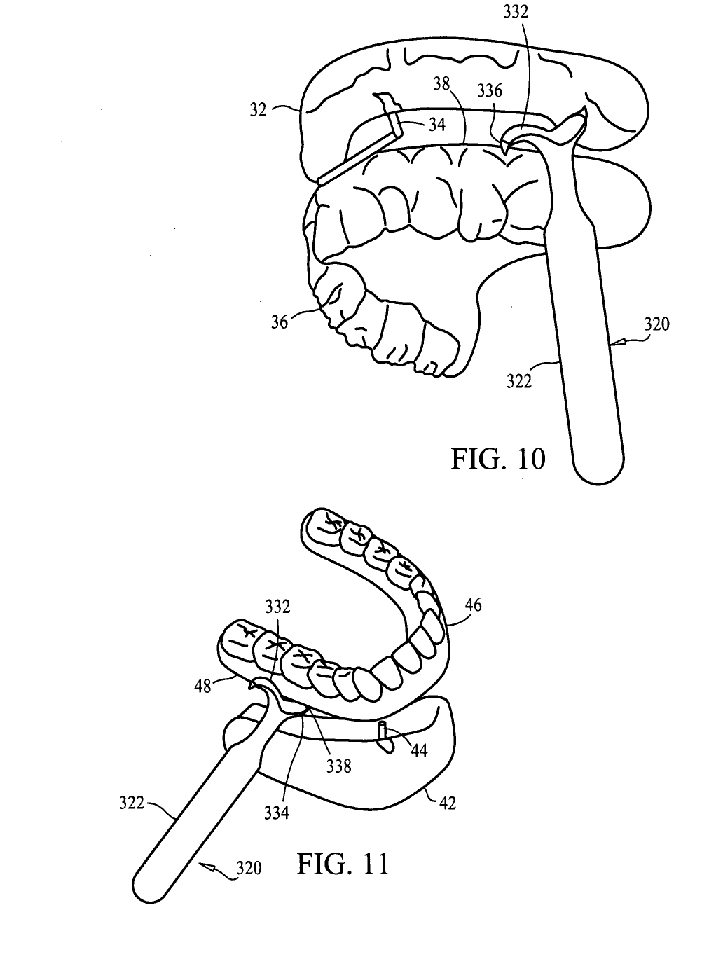

For purposes of description herein, the terms “upper”, “lower”, “left”, “rear”, “right”, “front”, “vertical”, “horizontal”, and derivatives thereof shall relate to the invention as oriented in FIGS. 1 and 10. However, one will understand that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Turning to the drawings, FIG. 1 shows a dental tool 120 which is one of the preferred embodiments of the present invention and illustrates its various components. Dental tool 120 has a shaft-like handle 122 which has a first end 124 and a second end 126. An engagement head 128 includes a neck 130 that is affixed to first end 124 of handle 122. Dual fingers 132 and 134 extend from an end of neck 130 opposite from handle 122. First finger 132 extends from head 128 in a generally upward manner for engaging a mandibular or lower dental prosthesis, and second finger 134 extends from engagement head 128 in a generally downward manner, and oppositely from finger 132, for engaging a maxillary or upper dental prosthesis. Both fingers 132 and 134 have a straight or linear configuration with rounded tips 136 and 138 respectively to prevent injury to the user's mucosa underlying the dental prosthetic.

FIGS. 2-8 illustrate alternate embodiments of dental tool 120 wherein alternately configured features thereof that correspond in description and function to those features of dental tool 120 will have reference numerals that have the same last two numerals while the preceding numeral will correspond to the figure number of the embodiment.

As illustrated in FIG. 2, an alternate embodiment dental tool 220 includes a handle 222 having first and second ends 224, 226 wherein a first engagement head 228 is affixed to first end 224 and a second engagement head 250 is affixed to second end 226. First engagement head 228 includes a neck 230 with first and second fingers 232 and 234 extending oppositely therefrom wherein first finger 232 extends substantially horizontally therefrom in a downwardly arcuate convex manner terminating at tip 236, and second finger 234 extends substantially vertically therefrom in an upwardly arcuate concave manner terminating at tip 238. As illustrated, finger 234 can also have an outer surface 235 that is generally shaped like a human fingernail. Second engagement head 250 affixed to second end 226 of handle 222 includes fingers 252 and 254 extending therefrom. Each of fingers 252 and 254 have a generally circular cross-section and extend from head 250 in an arcuately convex manner wherein the arcuate radius of second finger 254 is smaller than the arcuate radius of first finger 252 and in a manner such that first tip 256 extends in a direction away from handle 222 and second tip extends in a direction toward handle 222.

FIG. 3 illustrates alternate embodiment 320 wherein handle 322 includes first and second ends 324 and 326 with an engagement head 328 including a neck 330 affixed to first end 324. First finger 332 extends from engagement head 328 in a generally horizontal and downwardly convex manner. In like manner, second finger 334 oppositely extends from head 320 in a generally horizontal and upwardly concave manner. First and second fingers 332 and 334 are substantially rigid and terminate with resilient tips 336 and 338 affixed thereto, respectively. Further, first and second fingers 332 and 334 can also have generally convex upper surfaces 333 and 335 to provide a generally fingernail shaped configuration.

Turning to FIG. 4, dental tool embodiment 420 has an ergonomically teardrop shaped handle 422 having a first small end 424 to which engagement head 428 is affixed and a large second end 426 that more comfortably fits within the grasp of a user than a handle having a cylindrical configuration. Neck 430 of engagement head 428 has two segments 442 and 444 that are angularly arranged one with respect to the other. The angular arrangement of neck segments 442 and 444 facilitates a user holding handle 422 in a more comfortable position while simultaneously permitting fingers 432 and 434 to engage a dental prosthesis at an optimal angle. Downwardly extending finger 436 and upwardly extending finger 434 can be generally circular in cross-section and terminate at tips 436 and 438 that generally spherically configured to prevent injury to the mucosal layer underlying the dental prosthesis to be removed with dental tool 420.

Dental tool embodiment 520 as shown in FIG. 5 has a handle 522 with an alternate ergonomic configuration having ends 524 and 526 wherein engagement head 528 is affixed to handle end 524. Engagement head 528 has a bifurcated neck comprising first and second arms 560 and 562 arranged at an angle one to the other. First arm 560 includes first downwardly extending finger 532 terminating at tip 536 for engaging an upper dental prosthesis to be removed. In like manner, second arm 562 includes second upwardly extending finger 534 terminating at tip 538 for engaging a lower dental prosthesis to be removed.

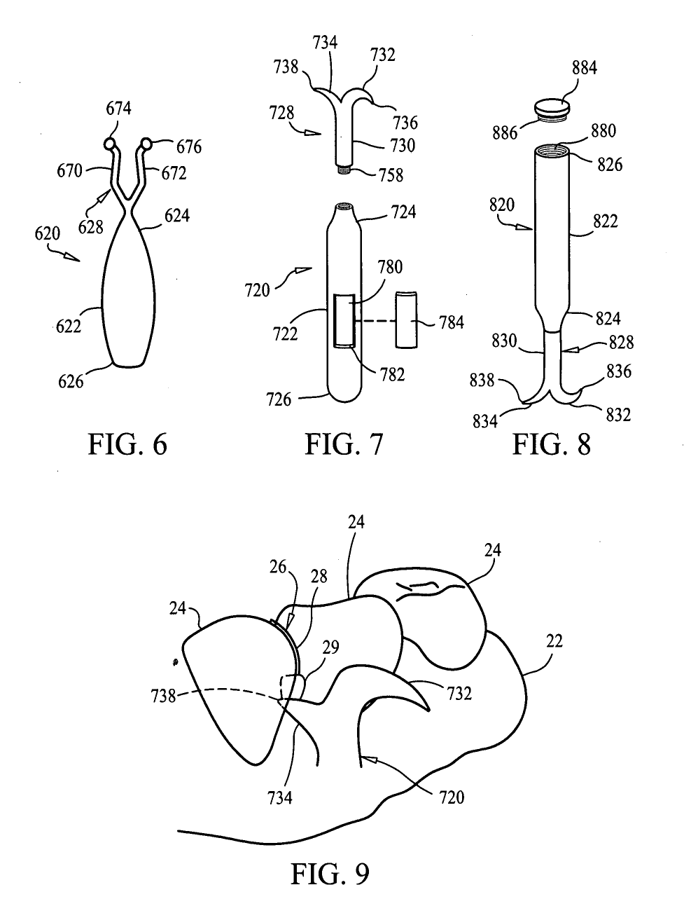

Turning to FIG. 6, an alternate embodiment dental tool 620 is illustrated with an ergonomic handle having ends 624 and 626 wherein an engagement head 628 is affixed to end 624. Engagement head 628 includes spaced apart arms 670 and 672 wherein arms 670 and 672 terminate with resilient suction cups 674 and 676 respectively for engaging a dental prosthesis. The suction cups 674 are diametrically sized to engage a continuous smooth surface of the prosthesis to be removed and to provide sufficient disengagement force to the prosthesis without disengaging from the continuous surface of the prosthesis to which the cups 674 and 676 are engaged.

FIG. 7 shows a dental tool embodiment 720 wherein handle 722 is formed such that it defines an internal void 780 that is accessible through aperture 782 which receives a removable panel 784. In this manner, handle 722 can be utilized for storage. Additionally, engagement head 728 can be removable from handle 722. Engagement head 728 has an engagement feature 758 such as threads or a snap-in retaining feature known in the art at an end of neck 730 which is received in end 724 of handle 722. Engagement head 728, like those previously, includes an upwardly extending finger 734 terminating at tip 738 and a downwardly extending finger 732 terminating at tip 736.

FIG. 8 illustrates an alternate embodiment dental tool 820 similar to dental tool 720 wherein handle 822 defines an internal void 880 which is accessible by removable end cap 884 at handle end 826. End cap 884 includes an engagement feature 886 such as threads or a snap-in retaining feature known in the art. Dental tool 820 includes engagement head 830 extending from handle end 824 and can, like the embodiment of dental tool 720, be removable. Engagement head 828, also like those previously, includes an upwardly extending finger 834 terminating at tip 838 and a downwardly extending finger 832 terminating at tip 836 for engaging a dental prosthesis.

In use, and as illustrated in FIGS. 9-13, the various dental tool embodiments, such as dental tools 320 and 720, are shown disengaging a dental appliance or prosthesis from a user's mouth. In FIG. 9, a dental appliance 26 is at least partially anchored in the user's mouth by a stainless steel wire 28 having a ball clasp 29 at an end thereof. Wire 28 is closely formed to the inner contour of the user's mandible 22 and extends upwardly and over the interstitial area between two adjacent teeth 24. Ball clasp 29 is firmly engaged in an undercut area of adjacent teeth 24. Since ball clasp is firmly engaged in the undercut area, it is difficult to disengage without the use of an instrument of one kind or another. By using dental tool 720, and more specifically upwardly extending finger 734, tip 738 can be inserted below ball clasp 29 by the user and urged upwardly around the contour of teeth 24 to disengage dental appliance 26 from the user's mouth.

As shown in FIG. 10, a user has a full maxillary denture 36 that fits to the user's maxillary arch 32. Maxillary arch 32 can also have one or more anchoring posts 34 that enhance the retention of denture 36. However, posts 34 also increase the force necessary to dislodge and remove denture 36. Dental tool 320 is used to aid in dislodging and removing denture 36 by engaging resilient tip 336 of downwardly extending finger 332 over a top edge 38 of denture 36 and then applying a downward force to handle 322 until denture 36 is dislodged from maxillary arch 32 and post 34. Denture 36 can then be grasped by the user and removed from the user's mouth.

FIG. 11 illustrates the use of dental tool 320 in the dislodgment of a full mandibular denture 46 from a user's mandibular arch. The denture 46 can also be anchored in place by one or more anchoring posts 44. Resilient tip 338 of upwardly extending finger 334 is engaged under a lower edge 48 of denture 46 whereupon the user exerts an upward force to handle 322 until denture 46 is dislodged from mandibular arch 42 and anchoring posts 44. Denture 46 can then be grasped by the user and removed from the user's mouth.

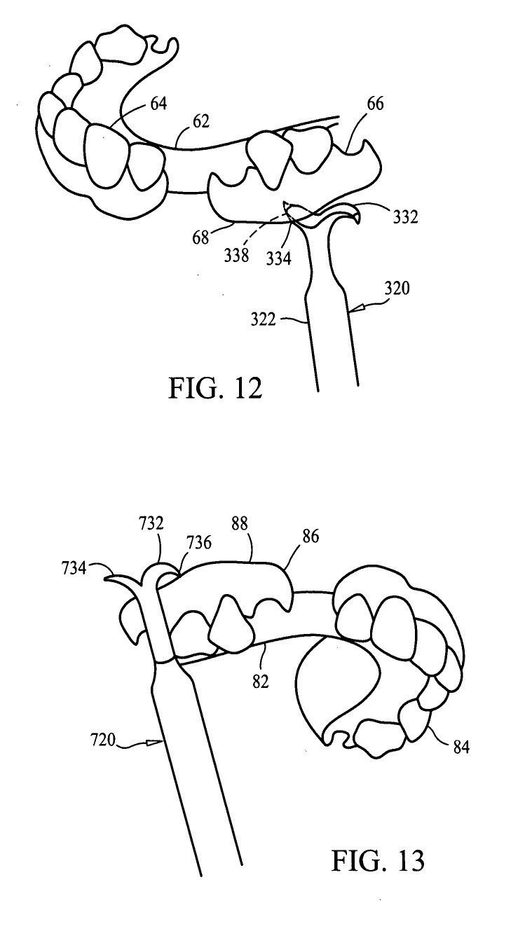

As shown in FIG. 12, a user has a partial mandibular denture 66 that is retained in an area of the user's mandibular arch 62 that is missing a series of teeth 64. To remove the partial denture 66, tip 338 of upwardly extending finger 334 is placed under lower edge 68 of partial denture 66 whereupon the user exerts a gentle upward force to handle 322 until partial denture 66 is dislodged. Partial denture 66 can then be manually removed from the user's mouth.

Referring now to FIG. 13, a user has a partial maxillary denture 86 that replaces a series of missing teeth 84. To remove the partial denture 86 with dental tool 720, the tip 736 of downwardly extending finger 732 is engaged over a top edge 88 of partial denture 86 whereupon a downward force is applied to handle 722 until partial denture 86 is dislodged. Once partial denture 86 is dislodged, the denture 86 can then be removed from the user's mouth.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the doctrine of equivalents.

What is claimed is:

1. A hand held dental tool for removing dental prostheses and dental appliances from a user's mouth, said dental tool comprising:
a handle; and
an engagement head affixed to a first end of said handle, said engagement head having dual fingers extending oppositely therefrom, wherein a first finger extends upwardly from said engagement head and a second finger extends downwardly from said engagement head.

2. The dental tool according to claim 1 wherein said fingers extend from said engagement head in a linear fashion.

3. The dental tool according to claim 1 wherein:
said first finger extends downwardly in a convex manner; and
said second finger extends upwardly in a concave manner.

4. The dental tool according to claim 1 wherein said fingers are substantially rigid and further wherein each said finger includes a resilient tip at a free end thereof.

5. The dental tool according to claim 1 wherein at least one surface of each said finger is formed in a fingernail-like shape.

6. The dental tool according to claim 1 wherein said engagement head includes a neck separating said engagement head from said handle and further wherein said neck is formed at an angle with respect to a longitudinal axis of said handle.

7. The dental tool according to claim 6 wherein said neck is bifurcated into a first and second arm and further wherein said upward extending finger extends from an end of said first arm and said downwardly extending finger extends from an end of said second arm.

8. The dental tool according to claim 1 further including a second engagement head affixed to a second end of said handle, said second engagement head including dual fingers extending oppositely therefrom.

9. The dental tool according to claim 8 wherein said fingers of said second dual fingered engagement head having a configuration different than said fingers of said first engagement head.

10. The dental tool according to claim 1 wherein said handle has an ergonomic shape for easy grasping.

11. The dental tool according to claim 1 wherein said engagement head is removable from said handle.

12. A hand held dental tool for removing dental prostheses and dental appliances from a user's mouth, said dental tool comprising:
a shaft like handle having first and second ends;
a neck extending from said first end; and
a first dual fingered engagement head formed at an end of said neck opposite from said handle wherein a first finger extends downwardly from said engagement head and an opposing second finger extends upwardly from said engagement head.

13. The dental tool according to claim 12 wherein said fingers extend from said engagement head in a linear fashion.

14. The dental tool according to claim 12 wherein:
said first finger extends downwardly in a convex manner; and
said second finger extends upwardly in a concave manner.

15. The dental tool according to claim 12 wherein said fingers are substantially rigid and further wherein each said finger includes a resilient tip at a free end thereof.

16. The dental tool according to claim 12 wherein at least one surface of each said finger is formed in a fingernail-like shape.

17. The dental tool according to claim 12 wherein at least a portion of said neck is formed at an angle with respect to a longitudinal axis of said handle.

18. The dental tool according to claim 12 wherein said neck is bifurcated into a first and second arm and wherein said upward extending finger extends from an end of said first arm and said downwardly extending finger extends from an end of said second arm.

19. The dental tool according to claim 12 further including a second neck extending from said second end of said handle and including a second dual fingered engagement head at a free end of said second neck.

20. The dental tool according to claim 19 wherein said fingers of said second dual fingered engagement head having a configuration different than said fingers of said first engagement head.

21. The dental tool according to claim 12 wherein said handle has an ergonomic shape for easy grasping.

22. The dental tool according to claim 12 wherein said engagement head is removable from said handle.

23. The dental tool according to claim 12 wherein said handle defines a hollow interior and includes a removable panel for access to said interior.

24. The dental tool according to claim 23 wherein said removable panel is a cap at a second end of said handle.

25. A hand held dental tool for removing dental prostheses and dental appliances from a user's mouth, said dental tool comprising:
a handle; and
a engagement head for engaging a dental appliance to be removed, said engagement head further comprising:
a first arm and second arm each extending away from said handle, each said arm having a suction cup affixed to a free end thereof, said suction cups being laterally separated one from the other and substantially coplanar.
